(19) United States
(12) Patent Application Publication
(10) Pub. No.: US 2015/0338025 A1
(43) Pub. Date: Nov. 26, 2015

(54) Energy Saving Device of Air Compressor

(71) Applicants: NAN-CHI CHEN, Xiushui Township (TW); WANG-CHUN CHEN, Xiushui Township (TW); CHIEN-HUNG CHEN, Xiushui Township (TW)

(72) Inventors: NAN-CHI CHEN, Xiushui Township (TW); WANG-CHUN CHEN, Xiushui Township (TW); CHIEN-HUNG CHEN, Xiushui Township (TW)

(21) Appl. No.: 14/285,690

(22) Filed: May 23, 2014

(51) Int. Cl. F17D 1/07; F15D 1/00

(52) U.S. Cl. CPC F17D 1/07; F15D 1/0015

(57) ABSTRACT

An energy saving for an air compressor is provided, including an inlet end of an inlet pipe being provided with an air filter, a connection end of the inlet pipe being connected to an inlet side of a compressor, an outlet side of the compressor being provided with an outlet pipe, an outlet end of the outlet pipe being connected to an air reservoir, an air supply side of the air reservoir being provided with an air supply pipe, mainly in that one or more accelerated pressurization pipes may be concatenated on the inlet pipe or outlet pipe or air supply pipe, the interior of the accelerated pressurization pipe is a through hole, the inner peripheral surface of the through hole is provided with several spiral grooves thereon, as an air flows through said accelerated pressurization pipe, the air flow is guided by the several spiral grooves naturally to rotate.

### BACKGROUND OF THE INVENTION

1. Field of the Invention

The present invention relates to the technical field of air compressors, and more particularly, provides an energy saving device of air compressor, which may concatenates one or more accelerated pressurization pipes on an inlet pipe or outlet pipe or air supply pipe of the air compressor; the accelerated pressurization pipe is provided with a through hole in the interior thereof and several spiral grooves on the peripheral surface thereof to accelerate pressurization of air flow, in order for power saving or supplying large pressure gas with a small compressor.

2. Descriptions of the Related Art

Lots of air compressors are used in the mechanical field. Air compressors are absolutely necessary in sites such as factory, automobile service factory, decoration & construction etc. However, the compressor power of an air compressor needs typically electric power or fuel oil. Therefore, if sufficient compression air may be accumulated in shortened shorter time, partial electric power or fuel oil may be saved relatively to achieve the effect of energy saving. It is still under development to achieve such a goal.

On the other hand, if accelerated pressurization is available for the output of compression air, the pressure may be increased definitely. Thereby, the air with larger pressure may be provided by a smaller compressor. Therefore, a smaller compressor may be purchased to reduce the equipment cost in procuring a compressor.

On a further hand, there are two styles for accelerated pressurization, one is power accelerated pressurization, and the other is natural accelerated pressurization. The power accelerated pressurization needs precise adjustment, and has to consider power quality, too. Further, the natural accelerated pressurization is the optimal option because there is no energy consumption problem, no adjustment, no need of power, which results in no need to consider power quality.

### SUMMARY OF THE INVENTION

It is an objective of the present invention to provide an energy saving for air compressor, which concatenates one or more accelerated pressurization pipes on an inlet pipe or outlet pipe or air supply pipe of the air compressor; the accelerated pressurization pipe is provided with a through hole in the interior thereof and several spiral grooves on the peripheral surface thereof to accelerate pressurization of air flow, in order for power saving or supplying large pressure gas with a small compressor.

In order to achieve the above and other objectives, the present invention provides an energy saving device for an air compressor, comprising: an inlet pipe, an inlet end of said inlet pipe being provided with an air filter, a connection end of said inlet pipe being connected an inlet side of a compressor, an outlet side of said compressor being provided with an outlet pipe, an outlet end of said outlet pipe being connected to an air reservoir, an air supply side of said air reservoir is provided with an air supply pipe, mainly being in that: one or more accelerated pressurization pipes may be concatenated on said inlet pipe or said outlet pipe or said air supply pipe, the interior of said accelerated pressurization pipe being a through hole, several spiral grooves being provided on the inner peripheral surface of said through hole, air flow being guided by the several spiral grooves to rotate for accelerated pressurization naturally as air flows through said accelerated pressurization pipe, for the requirement of pressure capacity to be achieved in shorter time in order for power saving, while the air flow being guided by the several spiral grooves to rotate for accelerated pressurization naturally as outputting, such that the air with larger air may be provided by a smaller compressor, the device cost is reduced, and the nature, instead of power, accelerated pressurization is utilized completely for the accelerated pressurization pipe. Therefore, there is no energy consumption problem, nor the problem that the power accelerated pressurization needs precise adjustment or is easy to suffer from the impact of power quality.

### BRIEF DESCRIPTION OF THE DRAWINGS

Objectives, features, and advantages of the present invention are hereunder illustrated with specific embodiments in conjunction with the accompanying drawings, in which:

FIG. 1 is a side schematic view of an accelerated pressurization pipe according to an embodiment of the present invention.

FIG. 2 is a front schematic view of an accelerated pressurization pipe according to the embodiment of the present invention.

FIG. 3 is a system flow chart of the present invention.

FIG. 4 is a perspective schematic view of an accelerated pressurization pipe according to the embodiment of the present invention.

FIG. 5 is a perspective schematic view of an accelerated pressurization pipe according to the embodiment of the present invention.

FIG. 6 is a plan cross-section view of an air compressor according to the embodiment of the present invention.

FIG. 7 is a plan action cross-section view of an air compressor according to the embodiment of the present invention.

### DETAILED DESCRIPTION OF THE EMBODIMENT OF THE INVENTION

The present invention provides an energy saving device for an air compressor.

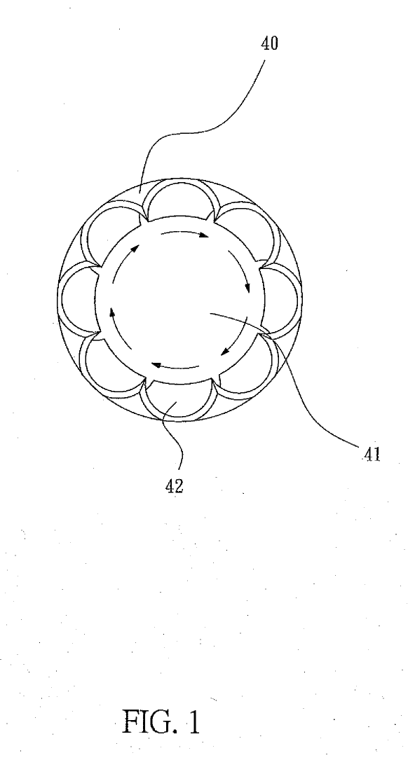

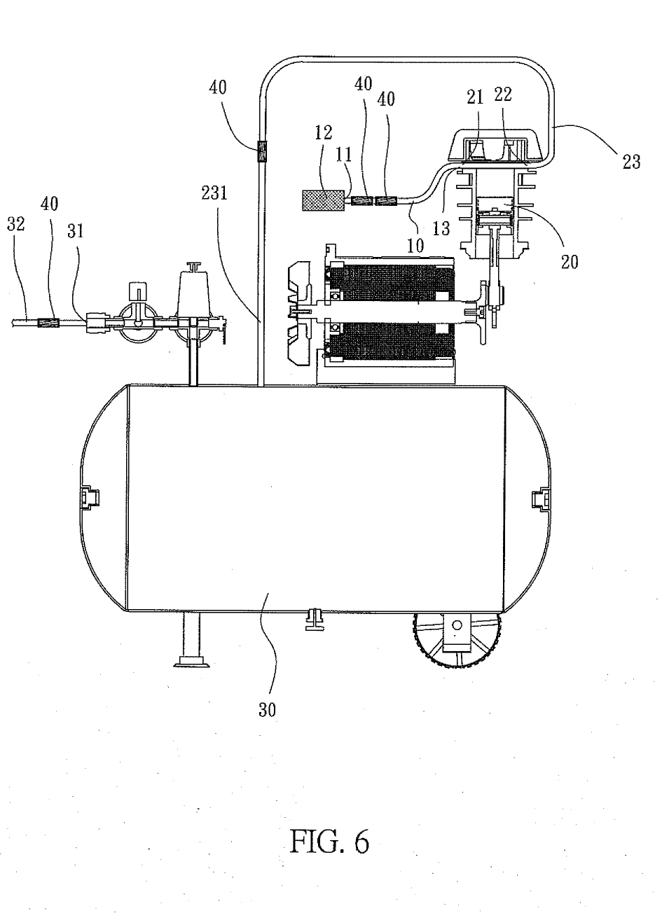

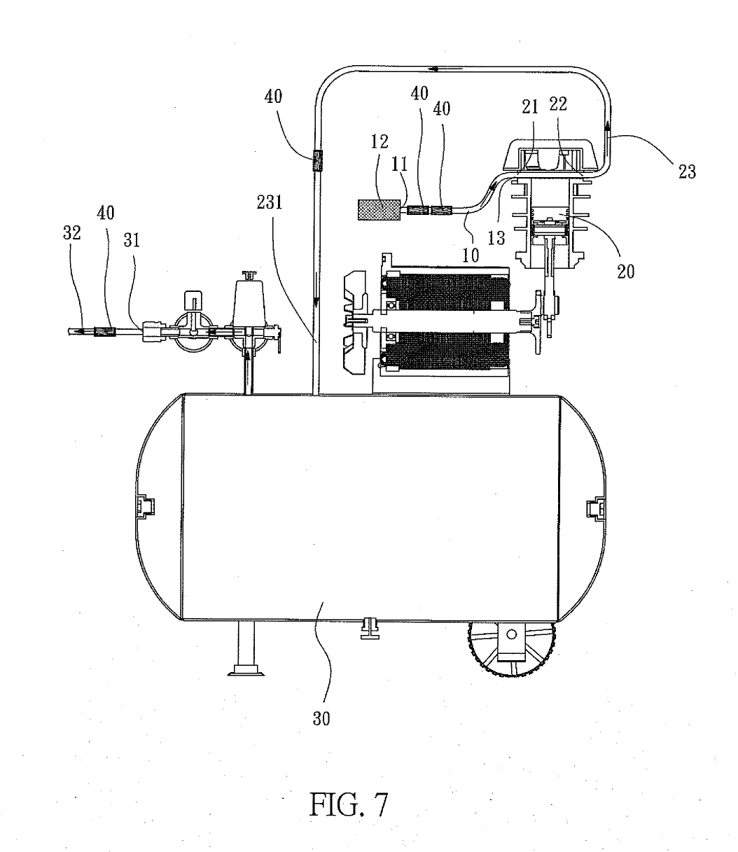

Referring to FIGS. 1 to 7, the present invention provides an energy saving device for an air compressor, comprising:

an inlet pipe 10, one inlet end 11 of said inlet pipe 10 being provided with an air filter 12;

a set of compressors 20, one connection end 13 of said inlet pipe 10 being connected to one inlet side 21 of said set of compressors 20, one outlet side 22 of said set of compressors 20 being provided with an outlet pipe 23; and

an air reservoir 30, one outlet end 231 of said outlet pipe 23 being connected to said air reservoir 30, one air supply side 31 of said air reservoir 30 being provided with an air supply pipe 32, mainly in that: one or more accelerated pressurization pipes 40 may be concatenated on said inlet pipe 10 or said outlet pipe 23 or said air supply pipe 32, the interior of said accelerated pressurization pipe 40 being a through hole 41, the inner peripheral surface of said through hole 41 being provided with three or more spiral grooves 42 thereon, an air flow being guided by said three or more spiral grooves 42 naturally to rotate for accelerated pressurization as an air flows through said accelerated pressurization pipe 40, such that the requirement of pressure capacity is achieved in shorter time for said compressor 20 for the air with larger pressure to be supplied by said smaller compressor 20. The arrangement cost is reduced. Moreover, the natural, instead of power, accelerated pressurization is utilized completely for said accelerated pressurization pipe 40. Therefore, there is no energy loss problem, nor the problem such as that eh power accelerated pressurization needs precise adjustment or is easy to suffer from the impact of power quality.

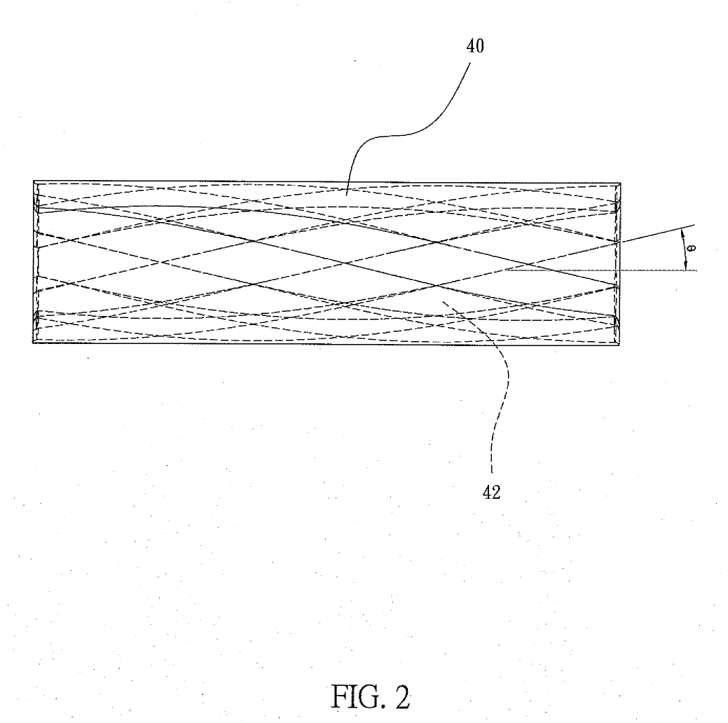

Referring to FIGS. 1 and 2, for said accelerated pressurization pipe 40 of the invention, three or more spiral grooves 42 are provided in said through hole 41, each of said spiral grooves forms an inclined angle θ seen from side, each of said spiral grooves 42 shows a groove line, which enforces rotation, seen from the front. Thus, the air flow is driven to rotate naturally for increased kinetic energy and an inclined angle θ for accelerated pressurization is formed, such that the passed smooth air flow is guided naturally to spin, and thereby, moves ahead with accelerated pressurization naturally. Furthermore, the predetermined pressure may be accumulated more quickly for more power saving, and a larger output power is available with a small air compressor.

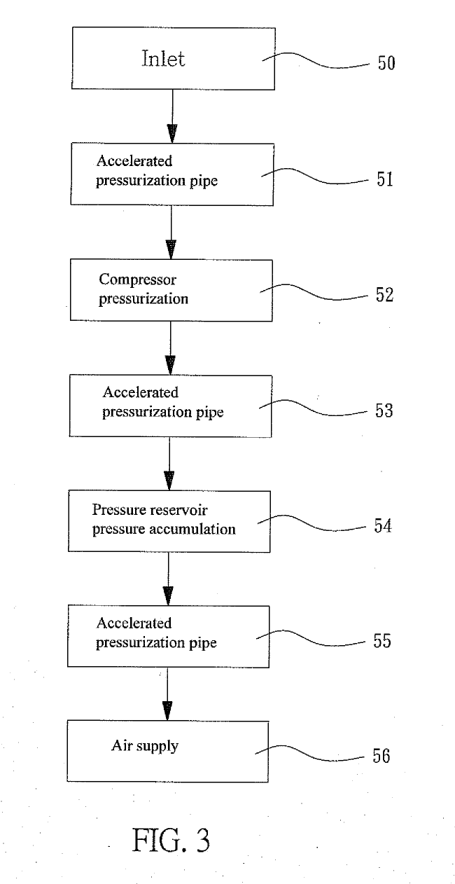

Referring to FIG. 3, an accelerated pressurization pipe 51 is provided between an inlet 50 and a compressor pressurization 52 to accelerate and pressurize air in a natural manner. Also, a compressor pressurization 52 and a pressure reservoir pressure accumulation 54 may be provided with an accelerated pressurization pipe 53 therebetween to accelerate and pressurize the air in a natural manner for the pressure reservoir pressure accumulation 54 to achieve the criteria more quickly. Thus, electric power may be saved. Moreover, an accelerated pressurization pipe 55 is provided between the pressure reservoir pressure accumulation 54 and an air supply 56 for enhanced flow rate and pressure of the air supply 56, such that larger power output is available by an compressor with smaller power.

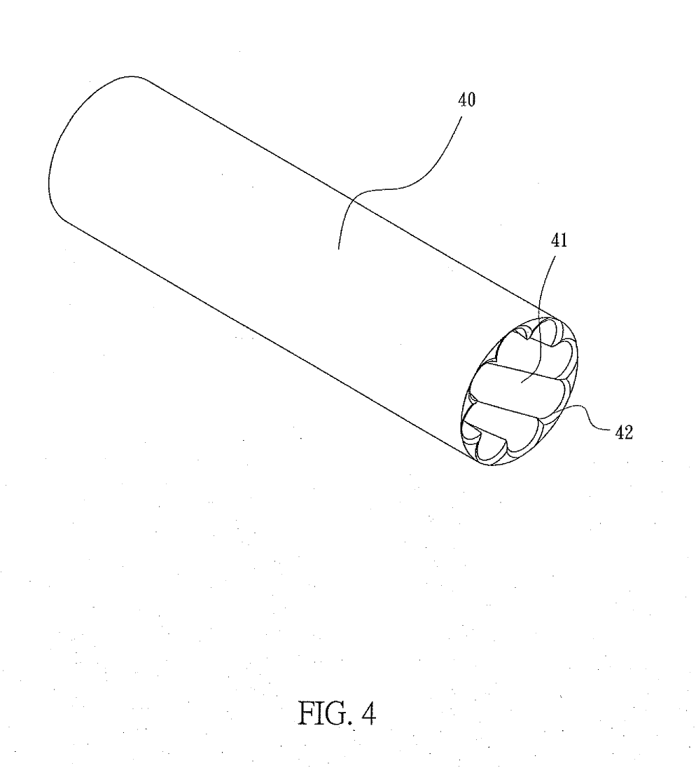

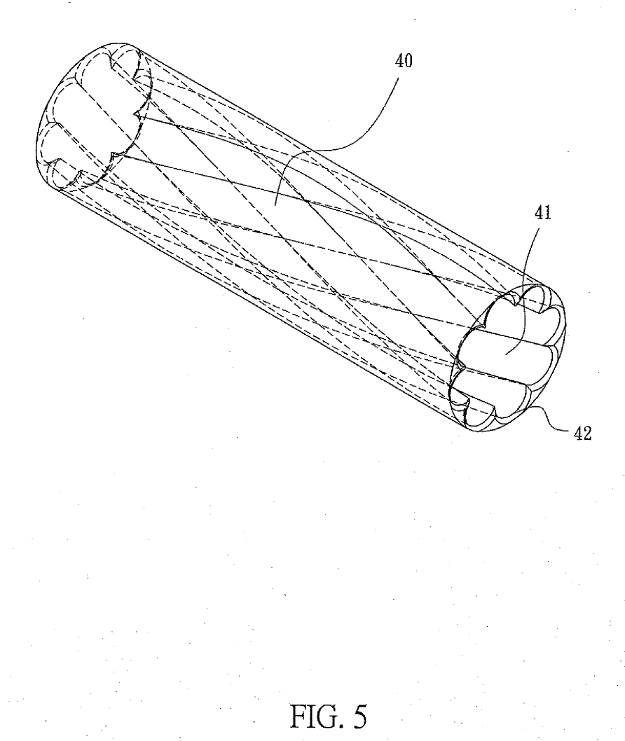

Refer to FIGS. 4 and 5, the interior of said accelerated pressurization pipe 40 is a through hole 41 according to the invention, the inner peripheral surface of said through hole 41 is provided with three or more spiral grooves 42 thereon. As an air flows through said accelerated pressurization pipe 40, the air flow is guided by said three or more spiral grooves 42 to rotate with acceleration and pressurization. Also, the natural, instead of power, accelerated pressurization is utilized completely by said accelerated pressurization pipe 40. Therefore, there is no energy loss problem, nor the problem that precise adjustment is necessary for, such as, power accelerated pressurization and it is easy to suffer from the impact of power quality.

From above, the energy saving device for an air compressor according to the invention does be innovative in the industry and comply with novelty of inventive patent. Its comprehensive inventive design complies with the requirement of advanced nature of inventive patent. Moreover, one or more accelerated pressurization pipes may be concatenated on the inlet pipe or outlet pipe or air supply pipe of the air compressor. The interior of the accelerated pressurization pipe is provided with a through hole in the interior therein and several spiral grooves on the peripheral surface thereon to accelerate and pressurize the air flow. Therefore, power may be saved or the air with larger pressure may be provided by a smaller compressor, such that the better industrial applicability is compliant.

What is claimed is:

1. An energy saving device for an air compressor, comprising:
an inlet pipe, one inlet end of said inlet pipe being provided with an air filter;
a set of compressors, one connection end of said inlet pipe being connected to one inlet side of said set of compressors, one outlet side of said set of compressors being provided with an outlet pipe;
an air reservoir, one outlet end of said outlet pipe being connected to said air reservoir, one air supply side of said air reservoir being provided with an air supply pipe, characterized in that:
one or more accelerated pressurization pipes being concatenated on said inlet pipe, the interior of said accelerated pressurization pipe being a through hole, the inner peripheral surface of said through hole being provided with three or more spiral grooves thereon, a lateral direction of each of said spiral grooves forming an inclined angle θ, a front direction of each of said spiral grooves forming a groove line enforcing rotation, as an air flows through said accelerated pressurization pipe, the air flow being driven to rotate naturally for increased kinetic energy and acceleration and pressurization with the inclined angle θ, such that said compressor achieves the requirement of pressure capacity in shorter time to save power further, and when outputting, the air flow being guided by said three or more spiral grooves to rotate with acceleration and pressurization naturally, so that an air with larger pressure may be provided with said smaller compressor in order for reduced arrangement cost, and natural, instead of power, acceleration pressurization being utilized completely for said acceleration pressurization pipe, so that there is no energy loss problem, nor the problems that a precise adjustment is necessary for, such as, the power accelerated pressurization or being easy to suffer from the impact of power quality.

2. An energy saving device for an air compressor, comprising:
an inlet pipe, one inlet end of said inlet pipe being provided with an air filter;
a set of compressors, one connection end of said inlet pipe being connected to one inlet side of said set of compressors, one outlet side of said set of compressors being provided with an outlet pipe;
an air reservoir, one outlet end of said outlet pipe being connected to said air reservoir, one air supply side of said air reservoir being provided with an air supply pipe, characterized in that:
one or more accelerated pressurization pipes being concatenated on said outlet pipe, the interior of said accelerated pressurization pipe being a through hole, the inner peripheral surface of said through hole being provided with three or more spiral grooves thereon, a lateral direction of each of said spiral grooves forming an inclined angle θ, a front direction of each of said spiral grooves forming a groove line enforcing rotation, as an air flows through said accelerated pressurization pipe, the air flow being driven to rotate naturally for increased kinetic energy and acceleration and pressurization with the inclined angle θ, such that said compressor achieves the requirement of pressure capacity in shorter time to save power further, and when outputting, the air flow being guided by said three or more spiral grooves to rotate with acceleration and pressurization naturally, so that an air with larger pressure may be provided with said smaller compressor in order for reduced arrangement cost, and natural, instead of power, acceleration pressurization being utilized completely for said acceleration pressurization pipe, so that there is no energy loss problem, nor the problems that a precise adjustment is necessary for, such as, the power accelerated pressurization or being easy to suffer from the impact of power quality.

3. An energy saving device for an air compressor, comprising:
an inlet pipe, one inlet end of said inlet pipe being provided with an air filter;
a set of compressors, one connection end of said inlet pipe being connected to one inlet side of said set of compressors, one outlet side of said set of compressors being provided with an outlet pipe;
an air reservoir, one outlet end of said outlet pipe being connected to said air reservoir, one air supply side of said air reservoir being provided with an air supply pipe, characterized in that:
one or more accelerated pressurization pipes being concatenated on said air supply pipe, the interior of said accelerated pressurization pipe being a through hole, the inner peripheral surface of said through hole being provided with three or more spiral grooves thereon, a lateral direction of each of said spiral grooves forming an inclined angle θ, a front direction of each of said spiral grooves forming a groove line enforcing rotation, as an air flows through said accelerated pressurization pipe, the air flow being driven to rotate naturally for increased kinetic energy and acceleration and pressurization with the inclined angle θ, such that said compressor achieves the requirement of pressure capacity in shorter time to save power further, and when outputting, the air flow being guided by said three or more spiral grooves to rotate with acceleration and pressurization naturally, so that an air with larger pressure may be provided with said smaller compressor in order for reduced arrangement cost, and natural, instead of power, acceleration pressurization being utilized completely for said acceleration pressurization pipe, so that there is no energy loss problem, nor the problems that a precise adjustment is necessary for, such as, the power accelerated pressurization or being easy to suffer from the impact of power quality.
